(19) United States
(12) Patent Application Publication
(10) Pub. No.: US 2011/0185349 A1
(43) Pub. Date: Jul. 28, 2011

(54) LAMP BALLAST CONFIGURED TO OPERATE IN A SELF-FORMING NETWORK

(75) Inventor: Paul Srimuang, San Diego, CA (US)

(73) Assignee: Empower Electronics, Inc.

(21) Appl. No.: 12/960,051

(22) Filed: Dec. 3, 2010

Related U.S. Application Data
(60) Provisional application No. 61/299,271, filed on Jan. 28, 2010.

(51) Int. Cl. G06F 15/16; G06F 9/44

(52) U.S. Cl. 717/171; 709/203

(57) ABSTRACT

A lamp ballast for a ballast system having a client device includes a lamp drive system, a control subsystem and a wireless communication subsystem. The lamp drive system delivers power to a lamp. The control subsystem controls operation of the lamp drive system. The wireless communication subsystem includes an embedded web server configured to display information on the client device indicative of a status of the lamp ballast. The embedded web server can generate a web page interface on the client device so that the client device can send a control signal to the control subsystem. The lamp ballast can receive information such as a status of a plurality of ballasts from a network of ballasts and can provide the information to the client device. The lamp ballast can receive a control signal from the client device and can pass the control signal to at least one of the plurality of ballasts in the network of ballasts. The wireless communication subsystem can broadcast the web page interface to the client through a plurality of different paths.

### RELATED APPLICATION

This application claims domestic priority under 35 U.S.C. §119(e) from U.S. Provisional Application Ser. No. 61/299,271 filed on Jan. 28, 2010, the entire contents of which are expressly incorporated herein by reference to the extent permitted.

### BACKGROUND

High intensity discharge (HID) arc lamps are in wide use for general illumination. Applications include roadside street lamps, sports arena illumination, stadium illumination, auto dealership illumination, warehouse illumination, and other purposes requiring a high power of illumination with high efficiency. They tend to be mounted at fairly high elevations requiring maintenance crews to replace.

When a lamp needs replacement, it is generally determined by a phone call to a utility company or an inspection by a maintenance crew. As a result a lamp that is not working or working marginally may not be replaced for a long time, creating safety issues. There have been attempts to improve this process with systems that automatically report the status of lamps.

One solution proposed is to provide each lamp with a wireless transmitter that transmits lamp status and to provide a base station that receives inputs from the lamp. The base station in turn would be coupled to the internet. The base stations must be located close enough together so that all ballasts can report their status. This has the disadvantage of requiring a costly infrastructure of base stations and internet connections.

Another solution proposed is to allow the ballasts to communicate a status through AC power lines. This eliminates the need for wireless base stations but adds the cost of specialized communication equipment that can communicate through the AC power system. It also relies on the AC power system to be operational and configured to allow this to function.

Proposed solutions can require specialized new infrastructures and, in some cases, rely on a good AC connection.

### SUMMARY

The present invention is directed toward a lamp ballast for a ballast system that includes a client device. In certain embodiments, the lamp ballast includes a lamp drive system, a control subsystem and a wireless communication subsystem. The lamp drive system delivers power to a lamp. The control subsystem controls operation of the lamp drive system. The wireless communication subsystem includes an embedded web server configured to display information on the client device indicative of a status of the lamp ballast.

In one embodiment, the embedded web server generates a web page interface on the client device so that the client device can send a control signal to the control subsystem. In another embodiment, the lamp ballast receives information from a network of ballasts and provides the information to the client device. This information can include a status of a plurality of ballasts in the network of ballasts.

In certain embodiments, the lamp ballast receives a control signal from the client device and passes the control signal to at least one of the plurality of ballasts in the network of ballasts.

In another embodiment, the wireless communication subsystem broadcasts the web page interface to the client through a plurality of different paths. These paths can include two or more of a direct wireless broadcast to the client device, an indirect wireless broadcast through another ballast and to the client device, and an indirect wireless broadcast through an internet access device, through the internet, and to the client device.

The present invention is also directed toward a method for controlling a lamp ballast, the method comprising the steps of providing a lamp ballast including (i) a lamp drive system, (ii) a control subsystem that controls the lamp drive system, and (iii) a wireless communication subsystem coupled to the lamp driver system; and transmitting information pertaining to the lamp ballast from the lamp ballast to a client device so that the client device displays a web page including the information pertaining to the lamp ballast.

### BRIEF DESCRIPTION OF THE DRAWINGS

FIG. 1 illustrates one embodiment of a ballast system having features of the present invention including a networked arrangement of ballasts and a client device;

FIG. 2 illustrates a block diagram of one embodiment of one of the ballasts depicted in FIG. 1;

FIG. 3 illustrates a more detailed block diagram of one embodiment of the ballast;

FIG. 4 illustrates various non-exclusive examples of software modules enabled by an embedded server of the present invention; and

FIG. 5 illustrates one embodiment of a web page that is utilized with the networked arrangement of ballasts.

### DESCRIPTION

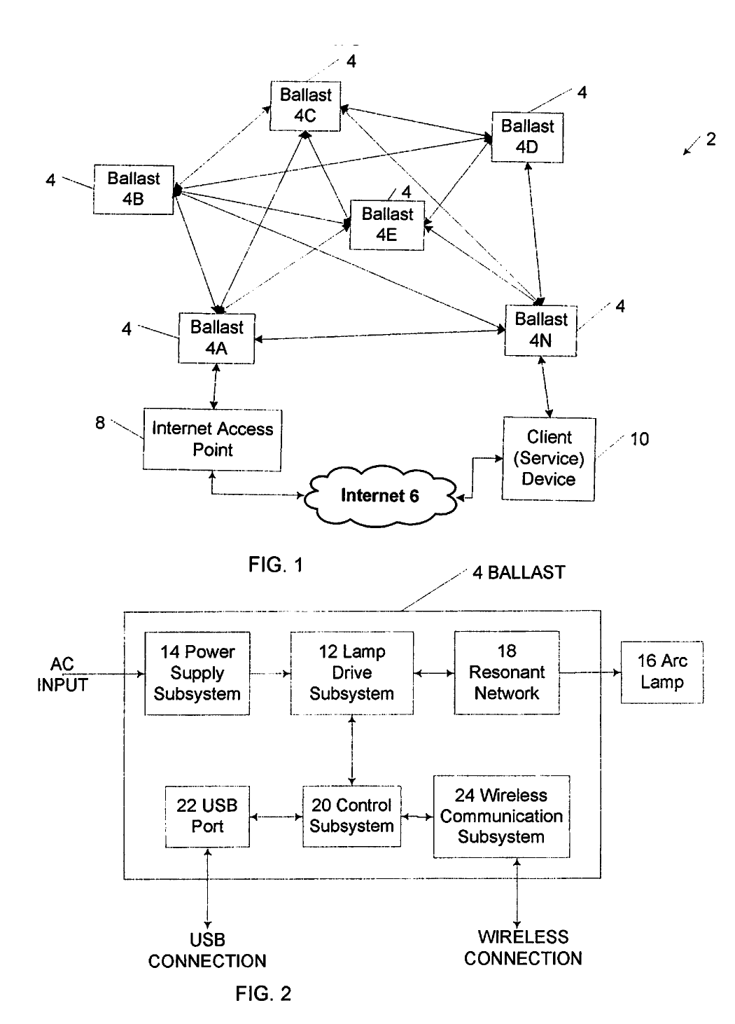

FIG. 1 illustrates one embodiment of a ballast system 2 including a network of ballasts 4 that are coupled to lamps and can also be wirelessly coupled to each other. In this embodiment, at least one ballast 4A is coupled to the internet 6 at an internet access point 8. Thus, in this embodiment, the entire network of ballasts 4 is thereby coupled to the internet 6 in a mesh network configuration. It is recognized that any one of many other configurations such as a daisy chain or ring network configurations can be employed, as non-exclusive examples.

In the embodiment illustrated in FIG. 1, client device 10 (also sometimes referred to herein as “client”) is also coupled to the internet 6. Client 10 may be a laptop computer, a PDA, a smart phone, a desktop computer, or any mobile or fixed computing device upon which web pages may be viewed. In the embodiment illustrated in FIG. 1, client 10 may also be wirelessly coupled directly to a ballast 4N. By accessing ballast 4N, the client can access information from any of the ballasts 4 in ballast system 2 even if one ballast is out of wireless range of client 10.

FIG. 2 illustrates one embodiment of an exemplary higher level block diagram of ballast 4 with certain details left out for clarity. Ballast 4 also includes a lamp drive subsystem 12 that receives power from power supply subsystem 14 and delivers power to HID lamp 16 via resonant network 18. In this embodiment, ballast 4 includes control subsystem 20 that is coupled to lamp drive subsystem 12, USB port 22, and wireless communication subsystem 24. Referring to FIGS. 1 and 2 collectively, subsystem 24 within ballast 4N is configured to broadcast and/or transmit a web page 40 (such as that illustrated in FIG. 5, for example) to client device 10 through multiple pathways including (1) directly via a wireless link from server 24 to client 10, (2) indirectly through another ballast such as ballast 4C, and/or (3) indirectly through the internet, internet access point 8, and the network of ballasts 4.

Having multiple different communication channels to ballasts 4 can have one or more of the following advantages. For example, the ballasts 4 can enable a remote centralized monitoring and/or can control the ballasts 4 via the internet access point 8. Since the network is self-configuring, only one internet access point is required for a very large network of ballasts 4 that may not all be within wireless range of the internet access point 8 since they can communicate through each other. This enables a relatively low cost infrastructure for internet control. Moreover, benefits of the ballast system 2 can be realized without an internet access point 8 since a client can directly or indirectly access all of the ballasts through a single wireless connection at one ballast 4.

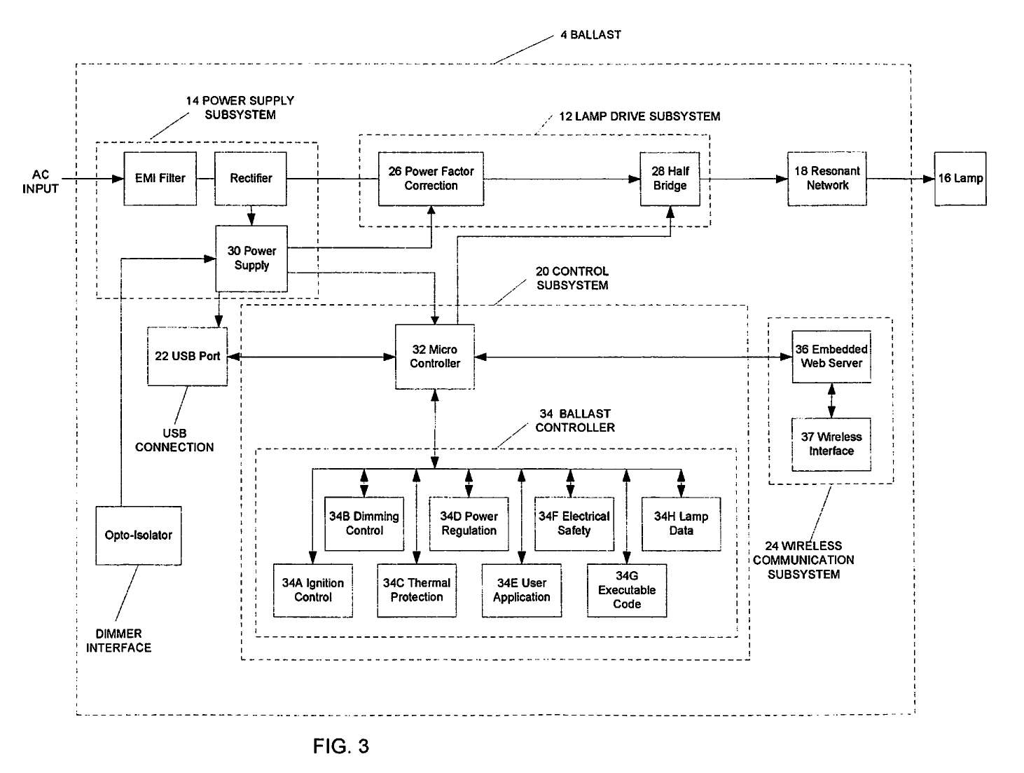

FIG. 3 illustrates an exemplary embodiment of ballast 4 in greater detail. In this embodiment, ballast 4 includes a lamp drive subsystem 12 configured to receive power from power supply subsystem 14 and to deliver power to lamp 16 via resonant network 18. In this embodiment, lamp drive subsystem 12 includes a power factor correction circuit 26 that delivers power to half bridge 28. In certain embodiments, half bridge 28 can be configured to deliver power to resonant network 18 and/or to control the frequency of a power signal delivered to resonant network 18 and lamp 16.

In one embodiment, control subsystem 20 receives power from power supply 30 and provides control signals to half bridge 28. Control subsystem 20 is configured to receive status information concerning current and voltage being delivered by lamp drive subsystem 12 to lamp 16. In this embodiment, control subsystem 20 is coupled to USB port 22 and to wireless communication subsystem 24.

Control subsystem 20 can include a micro-controller 32 coupled to a ballast controller 34. Ballast controller 34 has a number of software modules 34A-H. Modules 34A-H are depicted as exemplary software modules. In certain embodiments, ballast controller 34 is configured to control ignition of lamp 16 using ignition module 34A, enable dimming control using dimming control module 34B, provide thermal protection limits using thermal protection module 34C, and/or maintain a specified input power level to lamp 16 using power regulation module 34D, as non-exclusive examples.

Control subsystem 20 can communicate with wireless communication subsystem 24 via a connection between micro controller 32 and an embedded web server 36. Embedded web server 36 enables communication with a client device 10 via a wireless interface 37. Embedded web server 36 is configured to broadcast a web page to client device 10. The web page provides a user interface that enables client device 10 to interact with the software modules 34A-H.

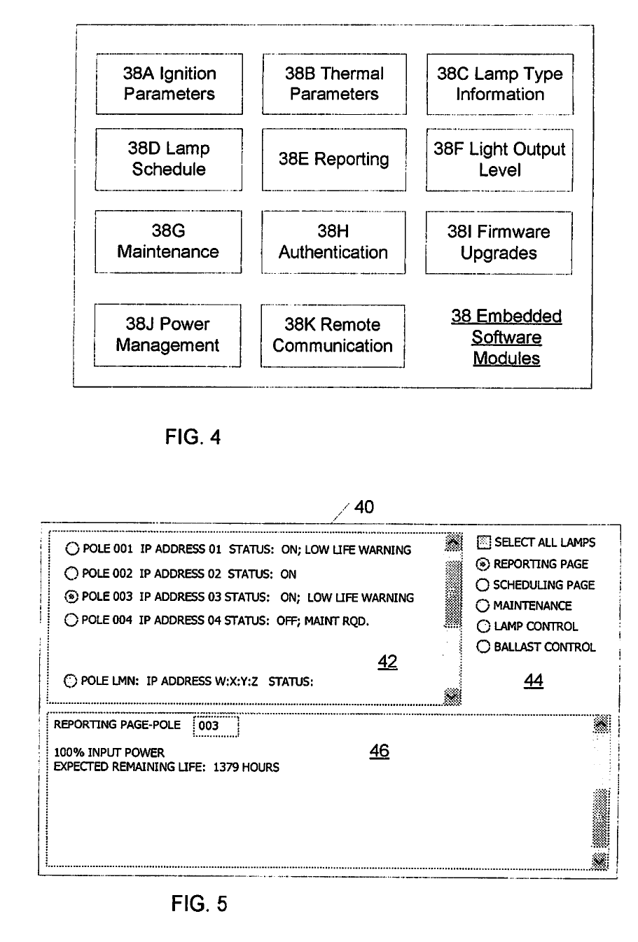

FIG. 4 illustrates one embodiment of a non-exclusive, exemplary set of web interface modules 38 configured to enable a user of client 10 to access various functions in ballast controller 34. Web server 36 is configured to display web interface 38 on client 10. A user of client 10 can review information from interface 38 and can input, control and/or otherwise specify to interface 38 to affect operation of ballast 4. In one embodiment, client 10 is configured to transfer those inputs to controller 34 via the web server 36. Web interface modules 38 may include ignition parameters 38A, thermal parameters 38B, lamp type information 38C, lamp schedule 38D, reporting 38E, light output level 38F, maintenance 38G, authentication 38H, firmware upgrades 381, power management 38J, and/or remote communication 38K, to name some non-exclusive examples.

In the embodiment illustrated in FIG. 4, web interface module 38A can enable client 10 to review and optimize parameters used for igniting lamp 16. Web interface module 38B can enable client 1,0 to review and optimize thermal safety parameters for ballast 4. Web interface module 38C can enable client 10 to input lamp type, manufacturer, and/or part number information when a lamp 16 is installed and coupled to ballast 4. In one embodiment, ballast controller 34 is configured to automatically optimize ballast operating parameters pursuant to the particular lamp 16 that is installed.

In one embodiment, web interface module 38D can enable client 10 to set lamp schedules that determine power levels versus time for each ballast 4 in ballast system 2 including when each ballast 4 is turned off and ignited. Web interface module 38E can provide a reporting web page that provides a status for each ballast 4. Web interface module 38F can provide web page that reports the illumination output of each lamp in network 4. Web interface module 38G can provide an interface that enables remote maintenance of each ballast 4. Web interface module 38H can be part of a login interface that requires a client 10 to authenticate itself to allow only authorized personnel to access the web pages for monitoring and controlling ballasts 4.

Web interface module 381 can enable a client to provide firmware and operating system updates to each ballast 4. Web interface module 38J can enable a client to control power related parameters for each ballast 4. Finally, remote communication interface module 38K can enable the adjustment and optimization of network related parameters.

Modules 38 may be defined differently or may overlap. For example, reporting module 38E may include the light output, obviating the need for the light out put level module 38F.

It is recognized that FIG. 4 illustrates one of many possible combinations of web interface modules, and that no limitations or restrictions are intended thereby. Stated another way, in alternative embodiments, certain web interface modules can be omitted, while in other embodiments, certain web interface modules that are not illustrated in FIG. 4 can be added. The specific combination of web interface modules illustrated in FIG. 4 is provided herein for ease of understanding and illustrative purposes.

FIG. 5 illustrates one embodiment of an exemplary web interface or web page 40 for accessing monitoring and/or control functions for each or all of a network of ballasts 4. The exemplary web page 40 is abbreviated for simplicity. In the embodiment illustrated in FIG. 5, the web interface 40 includes a list interface 42 listing ballasts that may identified according to pole number, IP address, or some other identifying number, letter, indicia, or any suitable combination thereof. Each indicated ballast may include a very brief status indication (on or off, warnings, power level, and/or historical data, etc., as non-exclusive examples).

The web interface 40 may also include a selection interface 44 for selecting which modules illustrated in FIG. 4 are to be monitored, controlled and/or otherwise viewed, for example. Just a few of these are shown in FIG. 5 for simplicity and for representative purposes. Selecting a combination of a lamp (or lamps or all lamps) from 42 and a module from 44 results in a function page 46 for one or more lamps. For example, the reporting page may display the input power level and the expected remaining life for a particular lamp. Other types of displayed information can be envisioned such as the shortest remaining life in lamps, power settings for groups of lamps, and/or histograms of remaining lamp lives useful for planned maintenance, just to name a few non-exclusive examples.

While the particular system and methods as shown and disclosed herein are fully capable of obtaining the objects and providing the advantages herein before stated, it is to be understood that they are merely illustrative of the presently preferred embodiments of the invention and that no limitations are intended to the details of the methods, construction or design herein shown and described.

What is claimed is:

1. A lamp ballast for a ballast system including a client device, the lamp ballast comprising:
a lamp drive system that delivers power to a lamp;
a control subsystem that controls operation of the lamp drive system; and
a wireless communication subsystem including an embedded web server configured to display information on the client device indicative of a status of the lamp ballast.

2. The lamp ballast of claim 1 wherein the embedded web server is configured to generate a web page interface on the client device to enable the client device to send a control signal to the control subsystem.

3. The lamp ballast of claim 1 wherein the lamp ballast receives information from a network of ballasts and provides the information to the client device, the information including a status of a plurality of ballasts in the network of ballasts.

4. The lamp ballast of claim 3 wherein the lamp ballast receives a control signal from the client device and passes the control signal to at least one of the plurality of ballasts in the network of ballasts.

5. The lamp ballast of claim 1 wherein the wireless communication subsystem broadcasts the web page interface to the client through a plurality of different paths.

6. The lamp ballast of claim 5 wherein the paths include two or more of:
(1) a direct wireless broadcast to the client device;
(2) an indirect wireless broadcast through another ballast and to the client device; and
(3) an indirect wireless broadcast through an Internet access device, through the internet, and to the client device.

7. A lamp ballast for a ballast system including a client device, the lamp ballast comprising:
a lamp drive subsystem that delivers power to a lamp;
a control subsystem coupled to the lamp drive subsystem; and
a wireless communication subsystem including an embedded web server that communicates between the control subsystem and the client device.

8. The lamp ballast of claim 7 wherein the embedded web server displays a web page upon the client device and receives updated operational parameters from the client device through the web page.

9. The lamp ballast of claim 7 wherein the control subsystem is configured to receive a software upgrade from the client device.

10. The lamp ballast of claim 9 wherein the embedded web server is configured to display a web page on the client device that facilitates the software upgrade.

11. The lamp ballast of claim 7 wherein the wireless communication subsystem communicates with the client device using a plurality of different communication paths.

12. The lamp ballast of claim 7 wherein the embedded web server is configured to:
(1) receive information from a first ballast that is indicative of a first set of ballasts in a network;
(2) receive information from a second ballast that is indicative of a second set of ballasts in the network; and
(3) display a list on the client device that is indicative of a union of the first set of ballasts and the second set of ballasts.

13. A method for controlling a lamp ballast, the method comprising the steps of:
providing a lamp ballast including (i) a lamp drive system, (ii) a control subsystem that controls the lamp drive system, and (iii) a wireless communication subsystem coupled to the lamp driver system; and
transmitting information pertaining to the lamp ballast from the lamp ballast to a client device so that the client device displays a web page including the information pertaining to the lamp ballast.

14. The method of claim 13 wherein the step of transmitting includes the web page communicating the status of the lamp ballast.

15. The method of claim 14 further comprising the steps of receiving control commands from the client device, transmitting the control commands to the lamp ballast, and adjusting operation of the ballast in response to the control commands.

16. The method of claim 13 further comprising the steps of:
displaying user modifiable parameters on the web page;
receiving inputs from the client device indicative of values of the parameters; and
modifying operation of the lamp ballast pursuant to the parameter values.

17. The method of claim 13 further comprising the steps of:
displaying an option for a software update on the web page;
receiving an indication from the client device of an acceptance of the software update; and
transferring the software update from the client device to the control subsystem.

18. The method of claim 13 further comprising the step of transferring executable code from the client device to the lamp ballast.

19. The method of claim 13 wherein the step of transmitting includes broadcasting the web page directly to the client device.

20. The method of claim 13 wherein the step of transmitting includes indirectly broadcasting the web page to the client device through one of: (1) another lamp ballast, and (2) an internet access device.
